(19) United States
(12) Patent Application Publication
(10) Pub. No.: US 2008/0230098 A1
(43) Pub. Date: Sep. 25, 2008

(54) Cooling/Heating System for Co2 Cleaning Machine

(76) Inventor: Kenneth S. Lindqvist, Skarpnack (SE)

Correspondence Address: The BOC Group, Inc., 575 MOUNTAIN AVENUE, MURRAY HILL, NJ, 07974-2082, US

(21) Appl. No.: 11/994,899

(22) PCT Filed: Jul. 4, 2006
(86) PCT No.: PCT/EP2006/006518

§ 371 Date: Apr. 15, 2008

(30) Foreign Application Priority Data
Jul. 28, 2005 (EP) 05016449.0

(51) Int. Cl. B08B 3/00

(52) U.S. Cl. 134/107

(57) ABSTRACT

The invention relates to a system for cleaning articles with liquid or supercritical carbon dioxide consisting of a cleaning chamber, a storage tank, a still with a vaporizer and a tube connecting said still with said storage tank, wherein said tube comprises a condenser. Heat is transferred between vaporizer and condenser by means of an external refrigeration cycle.

The invention relates to a system for cleaning articles with liquid or supercritical carbon dioxide comprising a cleaning chamber, a storage tank, a still with a vaporizer and a tube connecting said still with said storage tank.

Dense phase cleaning systems for cleaning articles with liquid or supercritical carbon dioxide are more and more common. Such systems normally include a cleaning chamber for treating the articles, a storage tank for liquid carbon dioxide and a still for purification of carbon dioxide that has been used in the process.

After the cleaning process has been completed liquid carbon dioxide is transferred from the cleaning chamber to the still and vaporized by heating with a heat exchanging medium. The resulting gaseous carbon dioxide is then condensed and conveyed back to the storage tank. Both, for the vaporization of the liquid carbon dioxide in the still as well as for the condensation of the vaporized carbon dioxide gas energy is consumed.

WO 00/56970 discloses an apparatus for cleaning textiles with liquid carbon dioxide which utilizes energy released during one process step in another process step in order to reduce the overall energy consumption. Gaseous carbon dioxide is sucked from the still by means of a compressor. The compressor gives off gaseous carbon dioxide at enhanced pressure and heat content. The gaseous carbon dioxide is passed through a heat exchanger in the still thereby vaporizing liquid carbon dioxide in the still. In this phase the gaseous carbon dioxide is condensed and then returned as liquid carbon dioxide to the storage tank.

The use of the heat created by the compressor to vaporize liquid carbon dioxide in the still and at the same time condensing gaseous carbon dioxide reduces the energy consumption compared to systems where separate heating and condensing means are used. The system is adapted to the vaporization process in the still and the condensation of gaseous carbon dioxide, but might not be flexible enough when it is necessary to cool or heat other system parts.

Thus it is an object of the invention to provide a system for cleaning articles with liquid or supercritical carbon dioxide which makes it possible to reduce the energy consumption and which can further be used to heat or cool other system parts.

This object is achieved by a system as defined above which comprises a condenser being in heat transferring contact with said tube connecting said still with said storage tank and an external refrigeration cycle being in heat transferring contact with said vaporizer and with said condenser.

According to the invention energy is transferred between the vaporizer used for the distillation of liquid carbon dioxide in the still and the condenser which is used to condense gaseous carbon dioxide transferred from the still to the storage tank. The energy is transferred via an external refrigeration cycle. The use of the external refrigeration cycle essentially improves the flexibility of the system.

As in any refrigeration cycle, in the external refrigeration cycle cold as well as heat is produced. Thus in the following the wording “refrigeration cycle” does not mean that such a cycle is only used for refrigeration or cooling, but according to the invention the “refrigeration cycle” is also used for heating another part of the system, in particular to vaporize liquid carbon dioxide in the still. Consequently the expression “refrigerant” refers to the heat exchanging medium which is circulated within the refrigeration cycle.

In a preferred embodiment of the invention the system further comprises an internal refrigeration cycle. The internal and the external refrigeration cycle are in heat transferring contact by two heat exchangers. The internal refrigeration cycle may be described as the actual cooling unit, which circulates an internal refrigerant. The internal refrigerant is alternately heated and cooled by conventional means, for example by compression and expansion. A first heat exchanger is arranged at the hot side of the cooling unit, a second heat exchanger at the cold side.

In the first heat exchanger heat is transferred from the hot internal refrigerant to the external refrigerant. The later one is then passed to the still to vaporize liquid carbon dioxide, whereby the external refrigerant is cooled. The so cooled external refrigerant is further cooled down in the second heat exchanger arranged at the cold side of the cooling unit, i.e. of the internal refrigeration cycle. Finally the cold external refrigerant is used to condense gaseous carbon dioxide.

The use of two refrigeration cycles, namely the external and the internal refrigeration cycle, is advantageous for the following reasons. It is then for example possible to use a mixture of water and glycol or a similar coolant as the refrigerant which is circulated within the external refrigeration cycle instead of the fluids which are normally used in cooling machines. With a water/glycol refrigerant less problems are expected with respect to maintenance and service of the cooling/heating system and in case of leaks in the refrigeration system.

The external and the internal refrigerant are circulated through the respective refrigeration cycles by means of a pump or a compressor.

By using an external refrigeration cycle instead of directly combining the vaporizer in the still with the condenser for condensing carbon dioxide, the invention provides a very flexible cooling and heating system. That flexibility is preferably increased by adding an additional heat exchanger to the external and/or to the internal refrigeration cycle.

In that respect it has been found advantageous to include an air-cooling system into the internal refrigeration cycle. The air-cooling system comprises a fan and a heat exchanger in order to cool the internal refrigerant by the ambient air. Instead of or in addition to an air-cooler it is also possible to use cooling water taken from an external source.

That additional heat exchanger in the internal refrigeration cycle has several advantages: First, it compensates the heat balance when the internal refrigeration cycle over all produces more heat than cold. Second, it increases the cooling capacity of the internal refrigeration system and thus makes it possible to not only condense gaseous carbon dioxide leaving the still, but also to cool other system parts. The invention may in particular be used to condense gaseous carbon dioxide and thereby reduce the pressure in other system units.

In the external refrigeration cycle an additional heat exchanger may for example be provided in order to heat the external refrigerant and to speed up the distillation process in the still.

It is further preferred to arrange a buffer in the external refrigeration cycle in order to reduce the maximum cooling capacity of the system. Cold produced at one time may be stored in the buffer and used at another time when there is additional demand for cold. The buffer can be an additional part added to the internal or the external refrigeration cycle. But it is also possible to use for example the liquid carbon dioxide within the still as a buffer. Further the cleaning chamber or the storage tank can be used for heat balancing the system in order to reduce the energy consumption.

The condenser, which is used to condense vaporized carbon dioxide from the still, could also be placed inside the storage tank. In that case the condenser may further be used to reduce the pressure within the storage tank by condensing part of the gas phase in the storage tank without running a separate carbon dioxide compressor.

The inventive system has several advantages compared to the prior art systems. The energy consumption is reduced during distillation. Energy is more or less only needed to compensate for losses in the distillation and cooling system. The invention makes it possible to reduce the running time of the CO2 compressor and makes it also possible to have a common distillation system for several cleaning machines. Such system will also be based on a more usual technique which means that the service will be less costly and could be done by local companies.

The still can run during the whole cleaning cycle except when emptying the cleaning chamber of gaseous carbon dioxide. By choosing the right capacity of the cooling unit and, if necessary, including an additional air-cooling system or similar additional cooling means, the distillation can run continuously.

The invention can further be used to increase or decrease the pressure or temperature of parts of the system in order to bring the cleaning machine into an optimum operation mode. For example it has also been found advantageous to increase the pressure of the carbon dioxide in order to achieve supercritical carbon dioxide for cleaning.

The invention can further be used together with other distillation methods in order to increase the distillation capacity or/and to decrease the energy consumption or to achieve other improvements as better temperature balance in the machine etc.

In order to speed up the distillation, the invention can also be combined with a compressor as described in WO 00/56970 (see introductory part of this specification). It is also possible to additionally increase pressure in the still by the inventive system.

The invention as well as additional details of the invention will now be described with reference to the embodiments shown in the drawings, in which

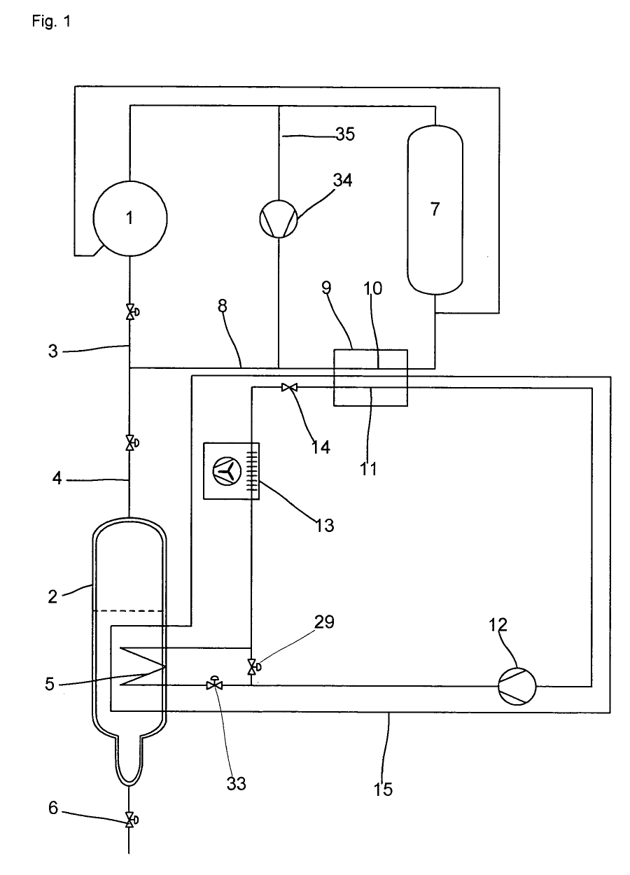

FIG. 1 shows an inventive system with one refrigeration cycle and

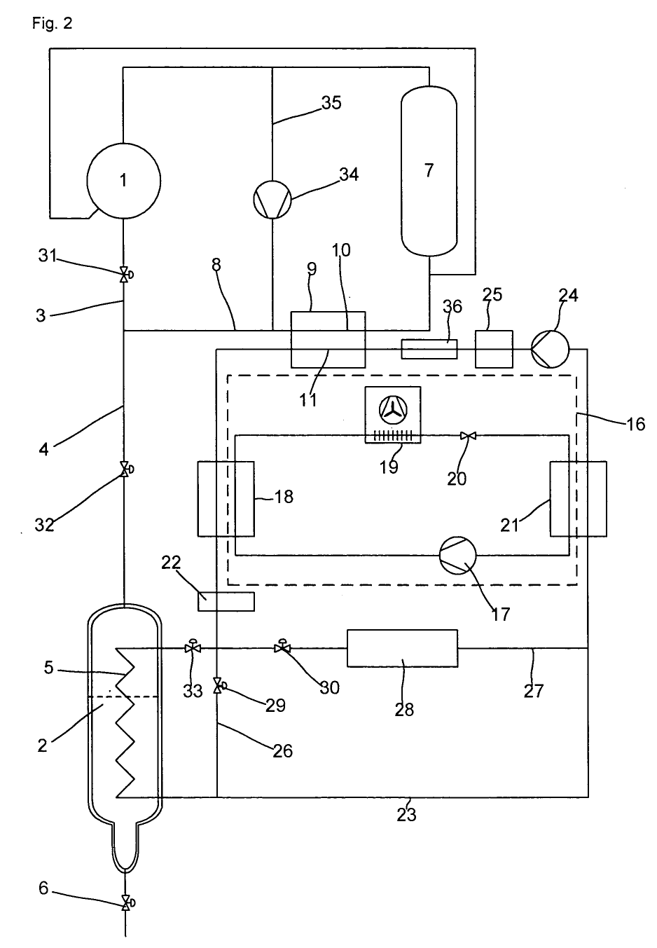

FIG. 2 shows an embodiment comprising an internal and an external refrigeration cycle.

With reference to FIG. 1 the inventive cleaning system comprises a cleaning chamber 1 in which the articles to be cleaned are introduced. The cleaning chamber 1 can be designed in several ways: The cleaning chamber 1 may comprise an internal basket to carry the material, articles, clothing or textiles which shall be cleaned. The basket may be arranged vertical or horizontal or rotatable. The cleaning chamber 1 may be equipped with spray nozzles to improve the cleaning performance. Further the cleaning fluid may be circulated by a liquid pump.

The cleaning chamber 1 is supplied with liquid carbon dioxide. Detergents or other additives may also be introduced into the cleaning chamber.

During the cleaning process the liquid carbon dioxide is polluted with detergent, chemicals or dye bleeding from garments. For recycling of the carbon dioxide used in the cleaning process, there is arranged a still 2 connected via tubes 3, 4 to the cleaning chamber 1. The still 2 is insulated and provided with a vaporizer 5 for vaporization of liquid carbon dioxide. Any waste separated from the carbon dioxide is drained off through line 6 at the bottom of the still 2.

The top of still 2 is connected to the storage tank 7 through tubes 4, 8. In conduit 8 condenser 9 is arranged for condensing vaporized carbon dioxide from still 2 prior to being introduced into storage tank 7. Condenser 9 is an indirect heat exchanger which comprises one set of passages 10 for the vaporized carbon dioxide and another set of passages 11 for an external refrigerant.

The heat exchanger passages 11 for the external refrigerant are part of an external refrigeration cycle. The external refrigeration cycle comprises in series a compressor 12, the vaporizer 5, an additional heat exchanger 13, an expansion valve 14 and the heat exchanger passages 11.

In the embodiment shown in FIG. 1 the external refrigeration cycle represents the cooling machine 15. A refrigerant circulated in the refrigeration cycle is compressed and thus heated by means of compressor 12. The heated refrigerant is passed through vaporizer 5 in the still 2 and vaporizes in indirect heat exchange liquid carbon dioxide. Then the refrigerant is cooled in the air-cooled heat exchanger 13 prior to its expansion in expansion valve 14. Due to the expansion, cold refrigerant is achieved which is then used to condense gaseous carbon dioxide which has been passed from still 2 through tubes 4, 8 to condenser 9. Finally the refrigerant is returned to compressor 12 for a new circulation.

Often the external refrigeration system creates more heat than cold. In order to balance the heat transfer into the still 2 by vaporizer 5 with the cold transfer into the gas stream of carbon dioxide in heat exchanger 9, it is advantageous to by-pass vaporizer 5 in still 2 by closing valve 33 and opening valve 29.

The inventive system allows to exchange energy between the vaporizer 5 and the condenser 9. The overall energy consumption is thus essentially reduced. Further the external refrigeration cycle may be used to cool or heat other parts of the system as it will be explained in detail with reference to FIG. 2.

Of course, in a complete system there are also temperature sensors, pressure sensors, liquid levels meters etc. used to control the process. Such sensors could be arranged in several ways for easy or more complex ways.

It is further possible to pass the compressed gaseous CO₂ after the compressor through a tube system or heat exchanger in the cleaning chamber in order to maintain the temperature in the cleaning chamber. Otherwise the temperature might drop far under 0° C. The rotation of the drum will move the CO₂ gas in the cleaning chamber through the coil. The rotation also turns the garments so no cold spots are created on the garments.

In addition, in a multiple machine installation a common system could be used which includes a large still, a large internal CO₂ tank and the inventive cooling system. The dedicated system for each individual machine are then a compressor and the cleaning chamber plus piping and instruments.

In FIG. 2 a preferred embodiment of the invention is shown which comprises an external and an internal refrigeration cycle. In FIGS. 1 and 2 identical reference numbers refer to identical parts.

In this embodiment the cooling machine 16 is represented by the internal refrigeration cycle. The internal refrigeration cycle comprises a serial arrangement of a compressor 17, a first hot heat exchanger 18, an air-cooling system 19, an expansion valve 20 and a second cold heat exchanger 21.

Through the first and the second heat exchangers 18 and 21 the internal refrigeration cycle is in heat transferring contact with an external refrigeration cycle. The main part of the external refrigeration cycle essentially comprises in series heat exchanger 18, additional heater 22, vaporizer 5, a tube 23, cold heat exchanger 21, a pump 24, a buffer 25, an optional extra water-cooled cooling unit 36 and condenser 9. The external refrigeration cycle further comprises a tube 26 to by-pass vaporizer 5 and a tube 27 which by-passes vaporizer 5 and tube 23. Tube 27 comprises another system part 28 to be heated.

Preferably a mixture of water and glycol is used as refrigerant in the external refrigeration cycle.

The way of operation of the inventive system will now be explained in two illustrative examples. The first example shows how to use the invention for the distillation of liquid carbon dioxide in the still 2, the second example describes a method to liquify carbon dioxide gas in another system part, for example in the storage tank 7.

For distillation of liquid carbon dioxide in still 2 compressor 17 of the internal refrigeration cycle is started. Thus the internal refrigerant is compressed and heated in compressor 17, passed through heat exchanger 18 in order to transfer heat to the external refrigerant, then cooled in air-cooler 19 before being expanded in expansion valve 20. The so cooled internal refrigerant transfers its cold to the external refrigerant in heat exchanger 21 before being returned to compressor 17 for a new circulation.

Pump 24 is started to circulate the external refrigerant. Valves 29 and 30 in tubes 26 and 27 are closed. The flow of the external refrigerant is as follows: The external refrigerant will be heated in the hot heat exchanger 18 by indirect heat exchange with the compressed hot internal refrigerant. In order to speed up the distillation process heater 22 is put into operation. Heater 22 transfers additional heat to the external refrigerant.

The hot external refrigerant is then passed through vaporizer 5 where heat is transferred from the external refrigerant to the liquid carbon dioxide in still 2 whereby the carbon dioxide in the still is vaporized and the external refrigerant is cooled. The external refrigerant is further cooled down in the second heat exchanger 21 before being pumped to condenser 9. If necessary, a buffer 25 is provided in order to store some of the cold of the external refrigerant.

In condenser 9 vaporized carbon dioxide from the top of still 2 and the cold external refrigerant are put into indirect heat exchange. The vaporized carbon dioxide will be condensed and can be fed to the storage tank 7.

Vaporizer 5 in still 2 is arranged in a way that the external refrigerant flows in a downward direction through vaporizer 5. The hot external refrigerant is first in indirect heat exchange with the warmer gas phase in still 2 and then with the cold liquid phase. Thus in still 2, a smooth boiling process of the liquid carbon dioxide is achieved.

Sometimes it might also be advantageous to do the opposite, i.e. to have the refrigerant flowing in an upward direction from the liquid carbon dioxide to the gas phase. This makes it possible to use all energy for vaporizing the liquid carbon dioxide with low or no over heating of the gaseous carbon dioxide. This alternative reduces the needed cooling capacity (“cooling energy”) per kg gaseous carbon dioxide in heat exchanger 9.

The vaporizer 5, which is preferably a coil, is designed to make it possible to vaporize essentially all liquid carbon dioxide in still 2 in order to improve the drain procedure.

As another example, with reference to FIG. 2 the use of the inventive system to liquify gaseous carbon dioxide in the storage tank 7 is described.

Valves 31 and 32 are closed. The flow connections between cleaning chamber 1 and still 2 as well as between storage tank 7 and still 2 are then closed.

The compressor 17 of the internal refrigeration cycle is started. Pump 24 for circulating the external refrigerant is also started. The air-cooler 19 is also started in order to produce as much cold as possible.

Valves 30 and 33 are closed so that the external refrigerant is by-passed around vaporizer 5 and any other additional system part 28 which is normally heated. If necessary, it is also possible to keep valve 30 and/or valve 33 open in order to heat the additional system part 28 or to vaporize liquid carbon dioxide in still 2. Heating of still 2 is advantageous since at a later stage the distillation process may be essentially accelerated.

Compressor 34 in the cleaning machine is started in order to have gaseous carbon dioxide flow from storage tank 7 through line 35 to condenser 9 and back into storage tank 7. In condenser 9 the gaseous carbon dioxide will be cooled down in heat exchange with the external refrigerant. The gaseous carbon dioxide, which passes the condenser 9 shall also mainly be condensed in condenser 9. However, the gas in the storage tank 7 and the material of storage tank 7 will function as a buffer, so that the pressure in the storage tank 7 will typically increased by 10 to 15 bar (which corresponds to 8 to 13 degree Celsius).

In general the invention can be used to cool any part of the cleaning system and heat another part 28. It is further possible to use the invention for cooling or heating only, for example as described above only for cooling gaseous carbon dioxide from the storage tank 7.

Depending on the part to be cleaned or heated gas compressor 34, a liquid carbon dioxide pump or any other circulating means may be used for moving gaseous or liquid carbon dioxide through heat exchanger 9 or any other heat exchanger which is in heat exchanging contact with the internal or external refrigeration cycle.

What is claimed is:

1. A system for cleaning articles with liquid or supercritical carbon dioxide having a cleaning chamber, a storage tank, a still with a vaporizer and a tube connecting said still with said storage tank, comprising a condenser being in heat transferring contact with said tube connecting said still with said storage tank, and an external refrigeration cycle being in heat transferring contact with said vaporizer and with said condenser.

2. The system according to claim 1, further comprising a first and a second heat exchanger arranged in said external refrigeration cycle, wherein said first and said second heat exchanger are in heat transferring contact with an internal refrigeration cycle.

3. The system according to claim 2, wherein a mixture of water and glycol is circulated within said external refrigeration cycle.

4. The system according to claim 1, further comprising a pump or a compressor to circulate a heat exchanging medium through said external refrigeration cycle or through said internal refrigeration cycle.

5. The system according to claim 2, further comprising a pump or a compressor to circulate a heat exchanging medium through said external refrigeration cycle or through said internal refrigeration cycle.

6. The system according to claim 1, further comprising at least one additional heat exchanger arranged in said external refrigeration cycle or said internal refrigeration cycle.

7. The system according to claim 1, further comprising at least one additional heat exchanger arranged in said external refrigeration cycle and said internal refrigeration cycle.

8. The system according to claim 2, further comprising at least one additional heat exchanger arranged in said external refrigeration cycle or said internal refrigeration cycle.

9. The system according to claim 2, further comprising at least one additional heat exchanger arranged in said external refrigeration cycle and said internal refrigeration cycle.

10. The system according to claim 6, wherein said additional heat exchanger arranged in said external refrigeration cycle is in heat transferring contact with another part of said system for cleaning articles.

11. The system according to claim 7, wherein said additional heat exchanger arranged in said external refrigeration cycle is in heat transferring contact with another part of said system for cleaning articles.

12. The system according to claim 8, wherein said additional heat exchanger arranged in said external refrigeration cycle is in heat transferring contact with another part of said system for cleaning articles.

13. The system according to claim 9, wherein said additional heat exchanger arranged in said external refrigeration cycle is in heat transferring contact with another part of said system for cleaning articles.

14. The system according to claim 1, further comprising a buffer in heat transferring contact with said external refrigeration cycle.

15. The system according to claim 2, further comprising a buffer in heat transferring contact with said external refrigeration cycle.

16. The system according to claim 1, wherein said condenser is located inside the storage tank.

17. The system according to claim 1, wherein said condensor is located outside the storage tank.

18. The system according to claim 2, wherein said condensor is located inside the storage tank.

19. The system according to claim 2, wherein said condensor is located outside the storage tank.
